(19) United States
(12) Patent Application Publication
(10) Pub. No.: US 2021/0227060 A1
(43) Pub. Date: Jul. 22, 2021

(54) MOBILE TERMINAL

(71) Applicant: LG ELECTRONICS INC., Seoul (KR)

(72) Inventors: Dongchul JIN, Seoul (KR); Samyoup KIM, Seoul (KR); Minwoo SONG, Seoul (KR)

(73) Assignee: LG ELECTRONICS INC., Seoul (KR)

(21) Appl. No.: 16/755,509

(22) PCT Filed: Oct. 12, 2017
(86) PCT No.: PCT/KR2017/011230

§ 371 Date: Apr. 10, 2020

(51) Int. Cl. H04M 1/02; H04N 5/232

(52) U.S. Cl. CPC H04M 1/0264; H04M 2250/20; H04N 5/23216

(57) ABSTRACT

A mobile terminal, which comprises: a body; a fixing unit disposed inside the body; a camera unit including a lens; a ball hinge for connecting the camera unit and the fixing unit to each other; and an angle-of-view adjustment unit for adjusting the ball hinge to control the direction of the lens of the camera unit, can widen an angle of view of a depth camera and can obtain a depth image having a high resolution.

### TECHNICAL FIELD

The present disclosure relates to a mobile terminal that includes an angle-of-view adjustment unit that may widen an angle of view of a camera unit.

### BACKGROUND ART

Terminals may be generally classified as mobile/portable terminals or stationary terminals according to their mobility. Mobile terminals may also be classified as handheld terminals or vehicle mounted terminals according to whether or not a user can directly carry the terminal.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

As such functions become more diversified, the mobile terminal can support more complicated functions such as capturing images or video, reproducing music or video files, playing games, receiving broadcast signals, and the like. By comprehensively and collectively implementing such functions, the mobile terminal may be embodied in the form of a multimedia player or device.

As a camera function of multimedia functions of a mobile terminal becomes important, resolution of the camera is more improved. In addition to one camera, the mobile terminal is provided with a camera having another function such as a wide angle camera and a depth camera, whereby a camera function is more enhanced.

The camera is used to not only simply store images/videos but also allow the mobile terminal to embody augmented reality based on information acquired from the camera.

### DISCLOSURE

### Technical Problem

An object of the present disclosure is to provide a mobile terminal that may enhance resolution of a depth camera by enlarging an angle of view of the depth camera.

### Technical Solution

A mobile terminal is provided, which comprises a main body; a fixed unit located in the main body; a camera unit that includes a lens; a ball hinge connecting the camera unit with the fixed unit; and an angle-of-view adjustment unit adjusting the ball hinge to control a direction of the lens of the camera unit.

The angle-of-view adjustment unit may include at least one fixed magnet located on a rear surface of the camera unit; a rotary unit that includes a plurality of moving magnets located at the same distance from the ball hinge; and a driver rotating the rotary unit based on the ball hinge, and the camera unit may be inclined based on the ball hinge in accordance with magnetism of the moving magnet facing the fixed magnet.

The moving magnet may be grouped as much as N, and N moving magnets of the same group are arranged at constant intervals.

The fixed magnet may include a plurality of fixed magnets which all belong to a first pole.

The fixed magnet may include four magnets arranged at an interval of 90°, and the moving magnet may include a first moving magnet, a second moving magnet arranged to be spaced apart from the first moving magnet at 90°, and a third moving magnet arranged to be spaced apart from the second moving magnet at an interval of 45°.

The moving magnet may include a plurality of moving magnets having different magnetic forces.

The mobile terminal may further comprise a bracket located around the camera unit, wherein the bracket may include an inclined surface facing the camera unit, widened toward an outer side.

The mobile terminal may further comprise an elastic pad attached to the inclined surface.

The ball hinge may include a ball coupled to the camera unit; and a ball housing surrounding the ball, and the ball housing may be provided with an entrance which is smaller than a maximum diameter inside the ball housing and made of a flexible material.

The camera unit may include a depth camera sensing a distance.

The mobile terminal may further comprise a case forming an external appearance of the main body and including a camera hole at a position corresponding to the camera unit; a camera window located in the camera hole; and a controller controlling brightness of the camera by calibrating light reflected from the camera window in accordance with a direction of the camera unit.

The mobile terminal may further comprise a controller selecting a subject based on distance information acquired through the lens of the camera unit and controlling the angle-of-view adjustment unit to allow the camera unit to be inclined toward a moving direction of the subject if the subject moves.

The mobile terminal may further comprise a controller selecting a focal distance based on distance information acquired through the lens of the camera unit and controlling the angle-of-view adjustment unit toward an angle-of-view boundary where an object located within the focal distance is located when the object is located in the angle of view boundary of the camera unit.

### Advantageous Effects

A mobile terminal according to the present disclosure has advantages in that it may widen an angle of view of a depth camera and obtain a depth image of high resolution.

Further scope of applicability of the present disclosure will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

FIG. 1A is a block diagram of a mobile terminal in accordance with the present disclosure.

FIGS. 1B and 1C are conceptual views of one example of the mobile terminal, viewed from different directions.

FIGS. 2 and 3 are views illustrating an angle of view of a camera module of a mobile terminal according to the present disclosure.

FIG. 4 is a view illustrating a camera module packaged in a mobile terminal of the present disclosure.

FIGS. 5a and 5b are views illustrating that an angle of a camera module of a mobile terminal of the present disclosure is changed.

FIGS. 6a and 6b are views illustrating another embodiment of a camera module of a mobile terminal according to the present disclosure.

FIGS. 7 and 8 are views illustrating driving of a camera module according to another embodiment of a camera unit of a mobile terminal of the present disclosure.

FIG. 9 is a view illustrating an angle of view of a mobile terminal according to the present disclosure.

FIG. 10 is a view illustrating an example of an angle-of-view adjustment unit according to the present disclosure.

FIG. 11 is a view illustrating a method for controlling an inclined direction of a camera unit by an angle-of-view adjustment unit of FIG. 10.

FIG. 12 is a view illustrating another example of an angle-of-view adjustment unit according to the present disclosure.

FIG. 13 is a view illustrating a method for controlling an inclined direction of a camera unit by an angle-of-view adjustment unit of FIG. 12.

FIG. 14 is a view illustrating an algorithm for controlling a camera module by a mobile terminal according to the present disclosure.

FIG. 15 is a view illustrating a screen captured when a camera module is controlled in accordance with FIG. 14.

FIG. 16 is a view illustrating another algorithm for controlling a camera module by a mobile terminal according to the present disclosure.

FIG. 17 is a view illustrating a screen captured when a camera module is controlled in accordance with FIG. 16.

FIGS. 18a and 18b are views illustrating light reflected from a camera window in accordance with an angle of a camera module of the present disclosure.

### BEST MODE FOR CARRYING OUT THE INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

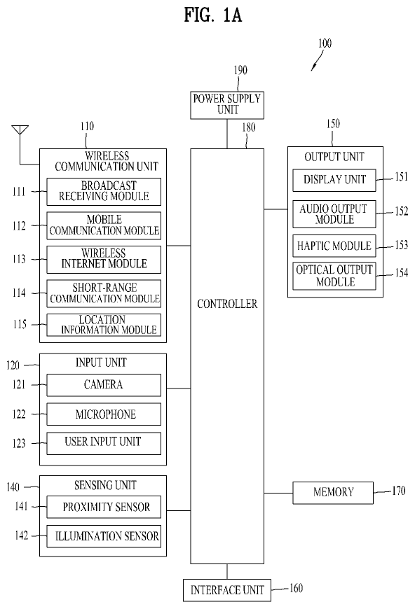

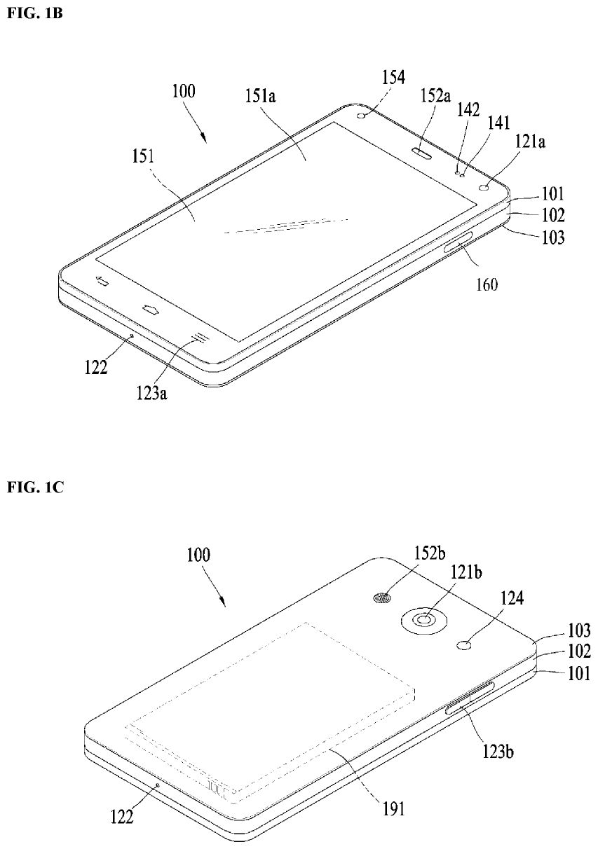

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. Referring now to FIG. 1A, the mobile terminal 100 is shown having wireless communication unit 110 configured with several commonly implemented components. It is understood that implementing all of the illustrated components is not a requirement, and that greater or fewer components may alternatively be implemented.

More specifically, the wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks.

To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, the sensing unit 140 may alternatively or additionally include other types of sensors or devices, such as a proximity sensor 141 and an illumination sensor 142, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output, or activating application programs stored in the memory 170.

To drive the application programs stored in the memory 170, the controller 180 may be implemented to control a predetermined number of the components mentioned above in reference with FIG. 1A. Moreover, the controller 180 may be implemented to combinedly operate two or more of the components provided in the mobile terminal 100 to drive the application programs.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

Some or more of the components may be operated cooperatively to embody an operation, control or a control method of the mobile terminal in accordance with embodiments of the present disclosure. Also, the operation, control or control method of the mobile terminal may be realized on the mobile terminal by driving of one or more application problems stored in the memory 170.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

Here, the terminal body may be understood to refer to the concept of this bore a mobile terminal (100) to at least one of the aggregate.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The mobile terminal 100 may include the display unit 151, the first and second audio output modules 152a and 152b, the proximity sensor 141, the illuminance sensor 142, the optical output module 154, the first and second cameras 121a and 121b, the first and second manipulation units 123a and 123b, the microphone 122 and the interface unit 160.

It will be described for the mobile terminal as shown in FIGS. 1B and 1C. The display unit 151, the first audio output module 152a, the proximity sensor 141, an illumination sensor 142, the optical output module 154, the first camera 121a and the first manipulation unit 123a are arranged in front surface of the terminal body, the second manipulation unit 123b, the microphone 122 and interface unit 160 are arranged in side surface of the terminal body, and the second audio output modules 152b and the second camera 121b are arranged in rear surface of the terminal body.

It is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

The display unit 151 outputs information processed in the mobile terminal 100. The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image. The first camera 121a can process image frames such as still or moving images obtained by the image sensor in a capture mode or a video call mode. The processed image frames can then be displayed on the display unit 151 or stored in the memory 170.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds. If desired, the microphone 122 may include assorted noise removing algorithms to remove unwanted noise generated in the course of receiving the external audio.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

A flash 124 is shown located adjacent to the second camera 121b. When an image of a subject is captured with the camera 121b, the flash 124 may illuminate the subject.

The second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 (see FIG. 1A), may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body.

The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen

Further preferred embodiments will be described in more detail with reference to additional drawing figures. It is understood by those skilled in the art that the present disclosure can be embodied in several forms without departing from the characteristics thereof.

A camera may include a depth camera, which measures a distance (depth) from a camera by receiving electromagnetic waves such as infrared rays or lasers, in addition to an image camera that records images by receiving visible rays. As compared with the camera that receives visible rays, the depth camera has drawbacks in that it has low resolution and narrow angle of view. Therefore, a problem occurs in that the depth camera should take images at low resolution or a bigger sized depth camera should be used to have the same angle of view as that of the visible ray camera. In case of low resolution, exactness of depth is reduced, whereby it is difficult to identify an exact object, and it is difficult to sense a user's gesture as a user input.

In this respect, the present disclosure suggests a camera module 200 that may obtain a depth image of high resolution by controlling a direction of a camera unit 220 to widen an angle of view. Although this is a structure for solving the drawbacks of the depth camera, this structure may be applied to a general camera to obtain an image of a wider angle of view or higher resolution.

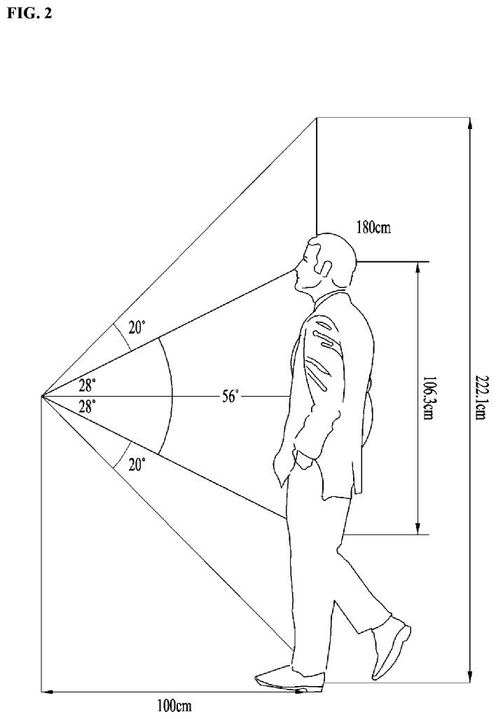

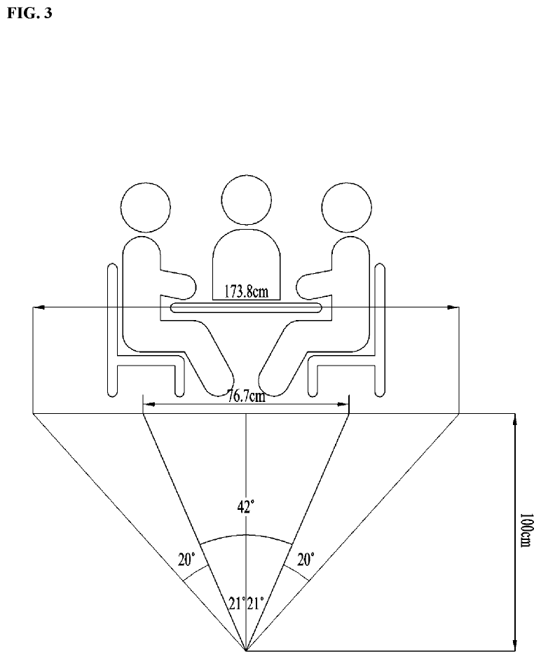

FIGS. 2 and 3 are views illustrating an angle of view of a camera module 200 of a mobile terminal 100 according to the present disclosure. FIG. 2 illustrates an angle of view of a vertical direction, and FIG. 3 illustrates an angle of view of a horizontal direction. At present, in case of a depth camera which is generally used, a vertical angle of view is 52°, and a horizontal angle of view is 42°. In this case, a depth image of vertical 106.3 cm and horizontal 76.7 cm size may be obtained from a spaced distance of 1-m.

An angle of view should be enlarged to take an adult man at a spaced distance of 1-m based on a height of 180 cm of the adult man, and people who sit in front of a table at a spaced distance of 1-m are not included in an angle of view of 76.7 cm. If the angle of view is increased at 20° from side to side or up and down, it may cover up to 222.1 cm up and down to take the adult man, and may cover up to 173.8 cm from side to side. That is, the camera module of the present disclosure may obtain a depth image of an angle of view corresponding to a general image by widening a full angle of view even though a camera unit of a narrow angle of view is used.

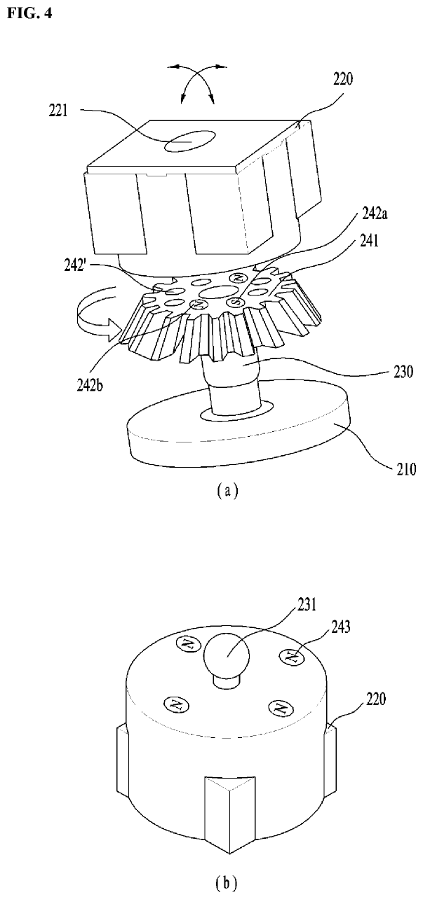

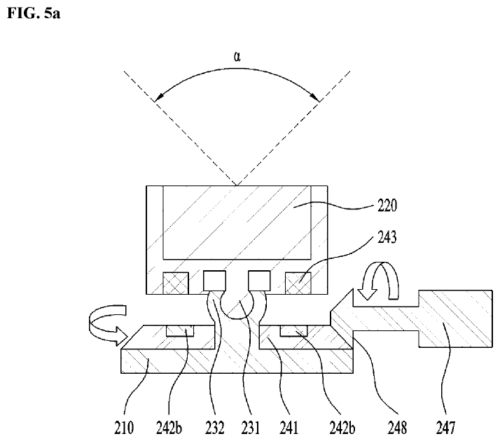

In this way, in order to widen the angle of view, the mobile terminal 100 of the present disclosure includes an angle-of-view adjustment unit 240 that may adjust a direction for which a lens is headed. FIG. 4(a) illustrates a camera module 200 packaged in the mobile terminal 100 of the present disclosure, wherein the camera module 200 of the present disclosure may be packaged on a front or rear surface of the mobile terminal 100. The camera module 200 of the present disclosure includes a camera unit 220, which includes a lens, a fixed unit 210 fixed to a main body of the mobile terminal 100, a ball hinge 230 connecting the fixed unit 210 with the camera unit 220, and an angle-of-view adjustment unit 240 controlling a direction of the lens of the camera unit 220 in accordance with movement of the ball hinge 230.

The camera unit 220 may be a general camera, or may be a depth camera that measures depth as described above. The camera unit 220 may be coupled with the fixed unit 210 fixed to the main body of the mobile terminal 100, through the ball hinge 230, thereby changing the direction of the lens 221 of the camera unit 220. Although an angle of a general hinge may be changed to only a specific direction, an angle of the ball hinge 230 may be changed in all directions of 360° and therefore may be inclined in various directions such as 45° and 30° in addition to up and down and from side to side directions.

FIG. 4(b) illustrates a bottom facing the fixed unit 210 of the camera unit 220, where a fixed magnet 243 fixed to the camera unit 220 and a ball 231 of the ball hinge 230 located at the center of the camera unit 220 are located. The ball 231 may be fitted into a ball housing 230 located in the fixed unit 210, whereby a direction of the camera unit 220 may be changed by movement of the ball within the housing.

The angle-of-view adjustment unit 240 of the present disclosure is provided to change the angle of the camera module 200. The angle-of-view adjustment unit 240 includes at least one fixed magnet 243 located on a rear surface of the camera unit 220, a rotary unit 241 that includes a plurality of moving magnets 242 located at the same distance from the ball hinge 230, and a driver for rotating the rotary unit 241 based on the ball hinge 230.

The fixed magnet 243 may be located on the bottom of the camera module 200 and include a plurality of magnets as shown in FIG. 4(b). The moving magnet 242 arranged to face the fixed magnet 243 is located on the rotary unit 241, and the moving magnet 242 and the fixed magnet 243 are arranged at the same distance from the ball hinge 230. The rotary unit 241 is rotated based on the ball hinge 230, and the driver for providing a dynamic power to rotate the rotary unit 241 includes a motor 247, a first gear 248 and a second gear 241.

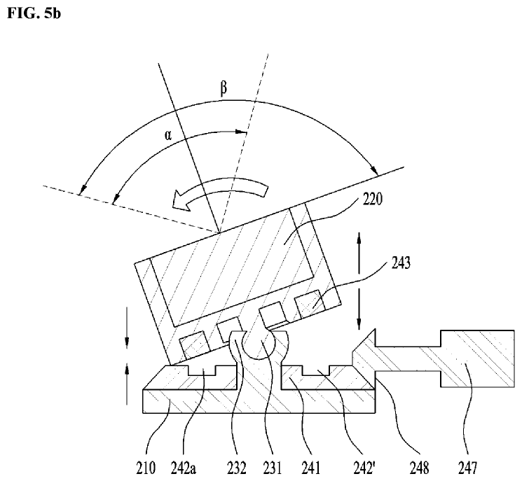

FIGS. 5a and 5b are views illustrating that an angle of a camera module 200 of a mobile terminal 100 of the present disclosure is changed. Since it is difficult to increase a thickness of the mobile terminal 100, the motor 247 cannot be arranged in a thickness direction to rotate the rotary unit 241, whereby a bevel gear is used.

The first gear 248 connected with the motor 247 and the second gear 241 rotated to be engaged with the first gear 248, having a rotary shaft different from that of the first gear 248 are provided. The second gear 241 may be embodied by forming sawteeth around the rotary unit 241. The first gear 248 and the second gear 241 may be provided with sawteeth arranged on an inclined surface, whereby the first gear 248 and the second gear 241 may be rotated to be engaged with each other even though they are rotated based on different shafts as shown in FIG. 5a.

Since a size of the first gear 248 cannot be more increased than the second gear 241 due to a restricted thickness of the mobile terminal 100, the number of sawteeth of the first gear 248 is different from the number of sawteeth of the second gear 241 and the first gear 248 may be rotated several times in order that the second gear may be rotated once. Although there is no limitation in the number of fixed magnets 243, the number of fixed magnets 243 may be 4, preferably, with reference to FIG. 4(b). If the number of fixed magnets 243 is 2, a direction that may be controlled is limited, and if the number of fixed magnets 243 is 4 or more, interference may be likely to occur between the respective magnets, whereby four fixed magnets may be arranged to be spaced apart from one another at 90°. Although the fixed magnets 243 having different polarities may be arranged, the fixed magnets having the same polarity may be arranged to more simply embody the angle-of-view adjustment unit 240. For convenience of description, the fixed magnet 243 will be described based on N pole. In case of the fixed magnet 243 based on S pole, in the following description, the moving magnet 242 may be embodied as an opposite pole of the fixed magnet to obtain the same effect.

The moving magnet 242 may be arranged on the rotary unit 241 as shown in FIG. 4(a), wherein the moving magnet 242b of N pole provides repulsion and the moving magnet 242a of S pole provides attraction. A pair of moving magnets 242b of N pole are arranged to be spaced apart from each other at 180°, and the moving magnet 242a of S pole has no corresponding moving magnet at a facing position. As shown in FIG. 5a, if the moving magnet 242b of N pole is arranged to overlap the fixed magnet 243, repulsion is uniformly provided to both sides, whereby the camera unit 220 is headed for a front surface. (An up direction is a front side in the drawing).

As shown in FIG. 5b, if the moving magnet 242a of S pole is arranged to overlap the fixed magnet 243, the camera unit 220 is inclined toward a direction where the moving magnet 242a of S pole is located. If the rotary unit 241 is rotated at 180°, the camera unit 220 is inclined in an opposite direction of FIG. 5b, whereby the angle of view is increased from a to β.

At this time, if the moving magnet 242a of S pole and the moving magnet 242b of N pole are arranged at 90°, the case that the camera unit is not inclined up and down as shown in FIG. 5a and the case that the camera unit is inclined to from side to side as shown in FIG. 5a may occur at the same time, whereby it is difficult to adjust the angle of view. Therefore, the moving magnet 242a of S pole and the moving magnet 242b of N pole may be arranged so as not to be 90° (for example, 45°). Also, if the moving magnet 242b of N pole instead of the moving magnet 242a of S pole is used, the camera unit 220 may be inclined using repulsion as shown in FIG. 5b.

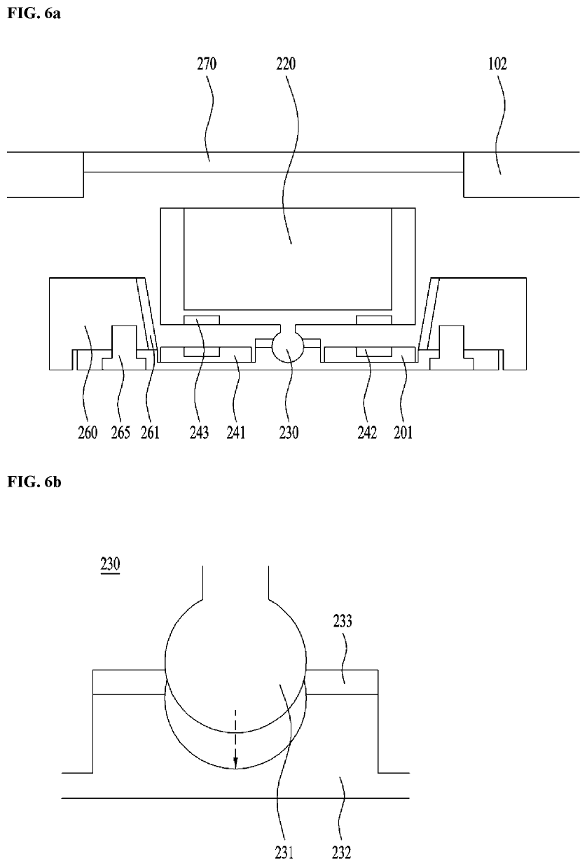

FIG. 6a illustrates another embodiment of a camera module of a mobile terminal according to the present disclosure. In order to embody the camera module 200 thinner than that of the aforementioned embodiment, the fixed magnet 243 and the moving magnet 242 may be provided at a thin thickness, a groove may be formed in the fixed unit 210 and then arranged in the rotary unit 241, a height from the fixed unit 210 of the ball hinge 230 may be lowered to reduce the thickness of the camera module 200.

FIG. 6b is a partially enlarged view of the ball hinge 230. An inlet of the ball housing 230 is made of a rubber 233 of a flexible material at a narrow diameter so that the ball 231 may be inserted into the ball housing 230 without being stuck out of the ball housing. Also, the rubber 233 may mitigate impact when the camera unit 220 is inclined to reach the rubber 233.

The camera module 20 may include a bracket 260 located around the camera unit 220. The bracket 260 includes a taper shaped inclined surface widened toward an outer side of the mobile terminal 100, that is, a front direction of the camera module 200. The inclined surface may include an elastic pad 261 that restricts rotation of the camera module 200 and mitigates impact when the camera module 200 reaches the inclined surface. The bracket 260 and the fixed unit 210 may be fixed using a screw 265.

A case forming an external appearance of the mobile terminal 100 may include a camera hole in which the camera module 200 is located, and a camera window to protect the camera module 200. If the camera module 200 is located on a front surface of the mobile terminal 100 and the front surface of the mobile terminal 100 is fully covered with a window glass, the window glass may partially be used as the camera window.

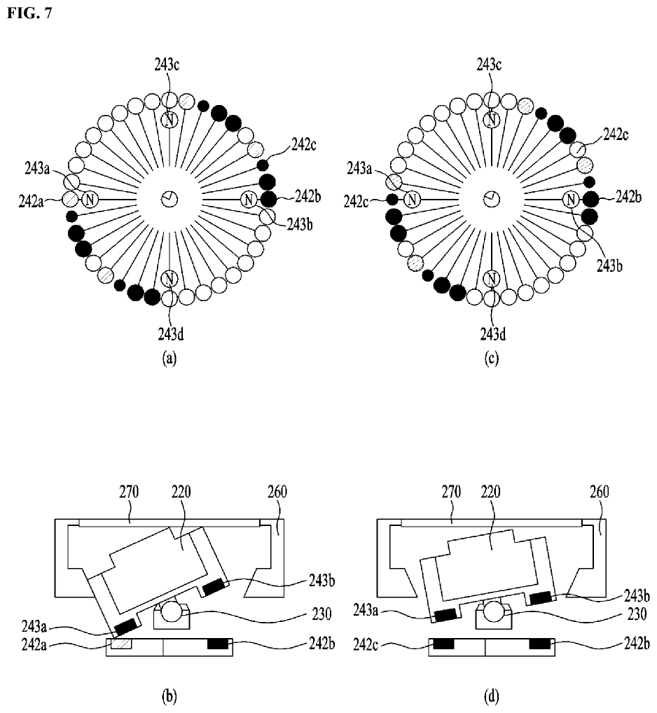

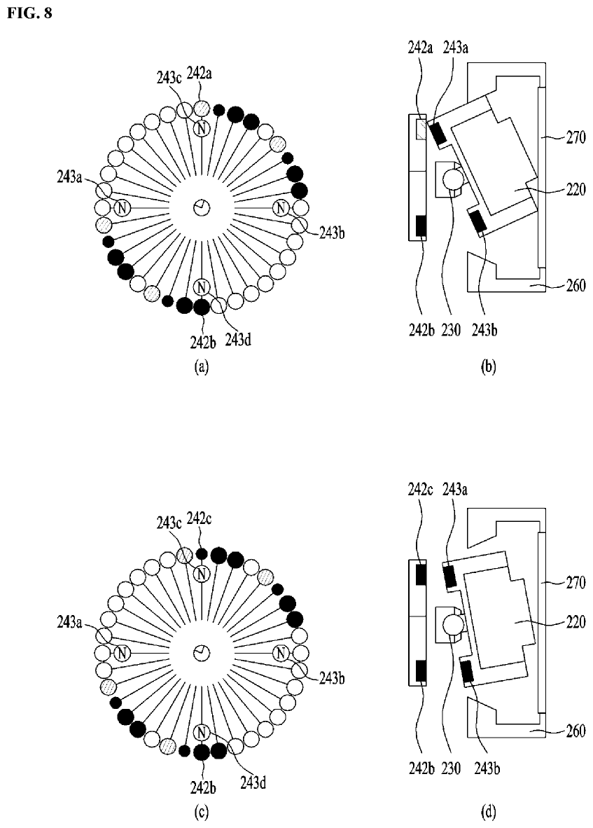

In the aforementioned embodiment, since the camera unit 220 is only inclined to the maximum range, it is impossible to finely adjust an angle of view. However, it is possible to more finely adjust an angle of view by varying intensity of magnetism. FIGS. 7 and 8 are views illustrating driving of a camera module 200 according to another embodiment of a camera unit 220 of a mobile terminal of the present disclosure. The fixed magnet 243 of this embodiment may be arranged with N pole in each of four directions, and the moving magnet 242 includes S pole 243a different from the fixed magnet 243, N pole 243b (hereinafter, referred to as “strong N pole”) having the same magnetism as that of the fixed magnet 243, and N pole 243c (hereinafter, referred to as “weak N pole”) weaker than the fixed magnet 243.

The moving magnets 242a and 242b of this embodiment are arranged at an interval of 10°, and includes four sets of S pole, weak N pole, and two strong N poles, wherein each set is arranged at an interval of 20° or 90°. In FIG. 7(a), the fixed magnets located from side to side are overlapped with the moving magnet 242 of S pole and the moving magnet 242 of strong N pole. As shown in FIG. 7(b), the camera unit 220 is inclined in a direction where the moving magnet 242 of S pole is located.

If the rotary unit 241 is rotated at 10° clockwise in a state of FIG. 7(a), the rotary unit 241 becomes the state of FIG. 7(b). The fixed magnets 243 arranged from side to side are overlapped with the moving magnet 242 of weak N pole and the moving magnet 242 of strong N pole. Since repulsion of weak N pole is weaker than the other poles, the camera module 200 is inclined in a left direction as shown in FIG. 7(d), and an inclined angle of the camera unit 220 of FIG. 7(d) is smaller than that of FIG. 7(b). That is, inclination of the camera unit 220 may finely be adjusted using the moving magnet 242 that varies intensity of magnetism.

If the rotary unit 241 is rotated at 10° counterclockwise in a state of FIG. 8(a), the fixed magnets 243 arranged up and down are overlapped with the moving magnet 242 of S pole and the moving magnet 242 of strong N pole. The camera module 200 is inclined in an up direction where the moving magnet 242 of S pole is arranged as shown in FIG. 8(b). The rotary unit 241 is more rotated at 10° counterclockwise and arranged as shown in FIG. 8(c), the fixed magnets 243 arranged up and down are overlapped with the moving magnet of weak N pole and the moving magnet 242 of strong N pole. Since repulsion of weak N pole is weaker than the other poles, the camera module 200 is inclined in an up direction as shown in FIG. 8(d). At this time, an inclined angle of the camera module 200 of FIG. 8(d) is smaller than that of FIG. 8(b). In this way, inclination of the camera unit 220 may gradationally be adjusted in four directions.

A set of two moving magnets 242 may only be provided to adjust the inclination. If an interval between the respective moving magnets 242 becomes narrow, the rotary unit 241 may be less rotated to adjust the inclination of the camera unit 220.

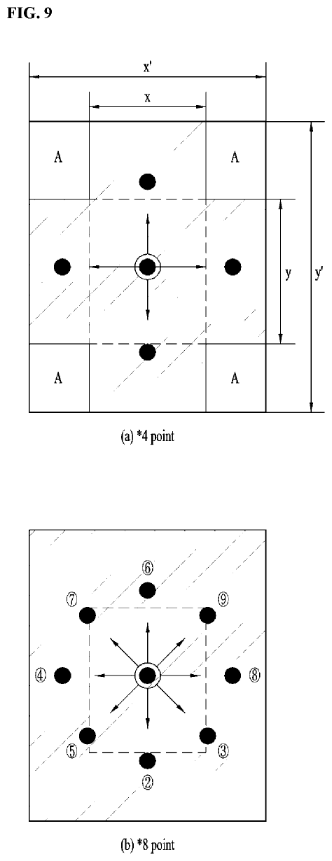

FIG. 9 is a view illustrating an angle of view of a mobile terminal 100 according to the present disclosure. If the camera unit 220 is inclined up and down or from side to side as described in the aforementioned embodiment, the angle of view is widened up and down and from side to side (x->x′ and y->y′). However, since a portion A located in a diagonal line cannot be taken as shown in FIG. 9(a), the angle-of-view adjustment unit 240 may be embodied such that the camera unit 220 is also inclined in a diagonal direction, whereby an image of a wide angle of view may be obtained without skip as shown in FIG. 9(b).

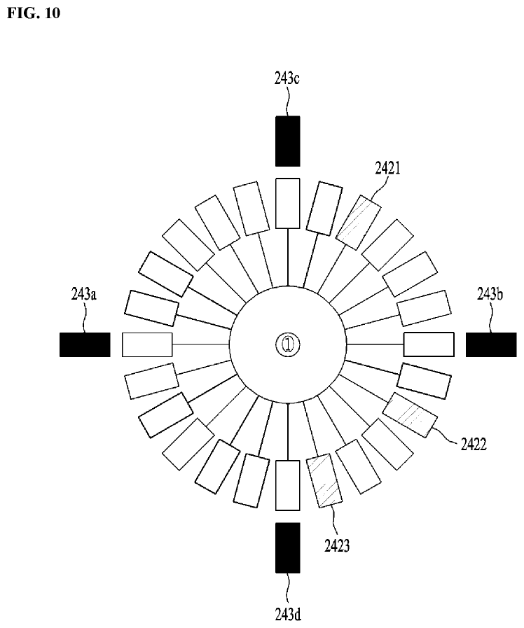

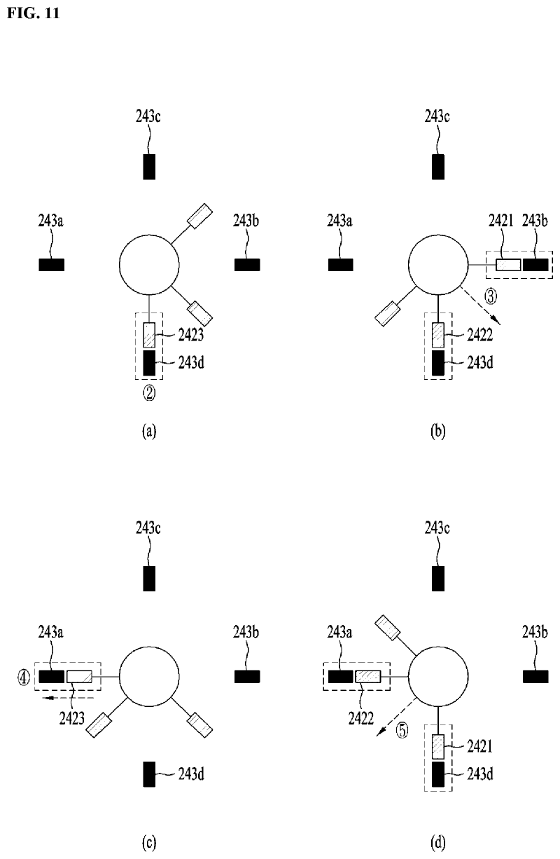

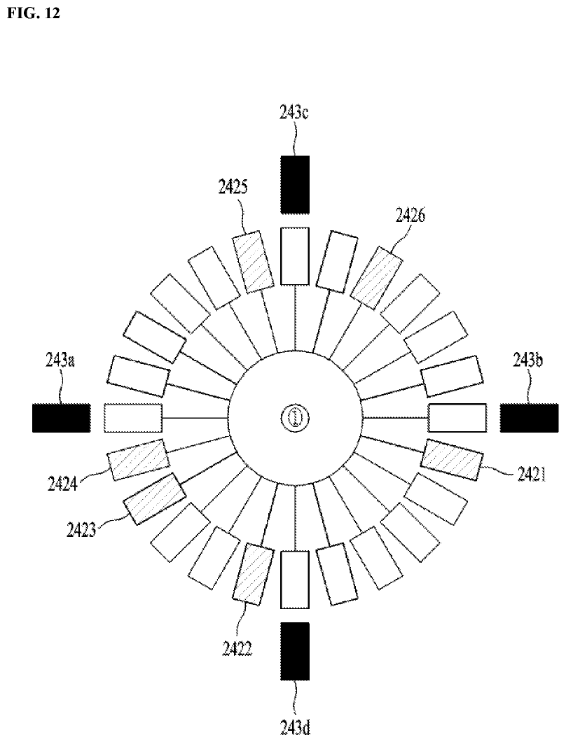

FIG. 10 is a view illustrating an example of an angle-of-view adjustment unit 240 according to the present disclosure, and FIG. 11 is a view illustrating a method for controlling an inclined direction of a camera unit 220 by an angle-of-view adjustment unit 240 of FIG. 10. The angle-of-view adjustment unit 240 of this embodiment may incline the camera unit 220 in a diagonal direction. The moving magnet 242 of this embodiment includes a first magnet 2421, a second magnet 2422 arranged to be spaced apart from the first magnet 2421 at 90°, and a third magnet 2423 arranged to be spaced apart from the second magnet 2422, and the fixed magnet 243 is arranged in four directions of up, down, left and right.

The fixed magnet 243 and the moving magnet 242 may have poles opposite to each other or the same pole. For convenience of description, if the fixed magnet 243 and the moving magnet 242 are overlapped by different poles, the camera unit 220 may be inclined in a direction where the fixed magnet 243 and the moving magnet 242 are overlapped with each other, due to attraction.

As shown in FIG. 11(a), the third magnet 2423 and a lower fixed magnet 243 are overlapped with each other, whereby the camera unit 220 is inclined toward a lower direction \textcircled{2}. If the rotary unit 241 is rotated at 45° clockwise and arranged as shown in (b), the first magnet 2421 and the second magnet 2422 are overlapped with the right fixed magnet 243 and the lower fixed magnet 243, and the camera unit 220 is inclined toward \textcircled{3}.

If the rotary unit 241 of 45° is rotated and therefore the moving magnet 242 is arranged as shown in (c), the third magnet 2423 and the left fixed magnet 243 are overlapped with each other, whereby the camera unit 220 is inclined toward \textcircled{4}. If the rotary unit 241 is rotated at 45° clockwise and therefore the moving magnet 242 is arranged as shown in (d), the first magnet 2421 and the second magnet 2422 are overlapped with the lower fixed magnet 243 and the left fixed magnet 243, and the camera unit 220 is inclined toward \textcircled{5}).

Although not shown, if the rotary unit 241 is rotated at 45° clockwise in FIG. 11(d), the camera unit 220 is inclined toward a direction \textcircled{6} shown in FIG. 9(b). If the rotary unit 241 is rotated at 90° clockwise in FIG. 11(d), the camera unit 220 is inclined toward a direction \textcircled{7} shown in FIG. 9(b). If the rotary unit 241 is rotated at 135° clockwise in FIG. 11(d), the camera unit 220 is inclined toward a direction \textcircled{8} shown in FIG. 9(b). If the rotary unit 241 is rotated at 180° clockwise in FIG. 11(d), the camera unit 220 is inclined toward a direction \textcircled{9} shown in FIG. 9(b). That is, the rotary unit 241 may be rotated as much as 45° to control the camera module 200 to be inclined toward the directions \textcircled{1}-\textcircled{9} of FIG. 9(b).

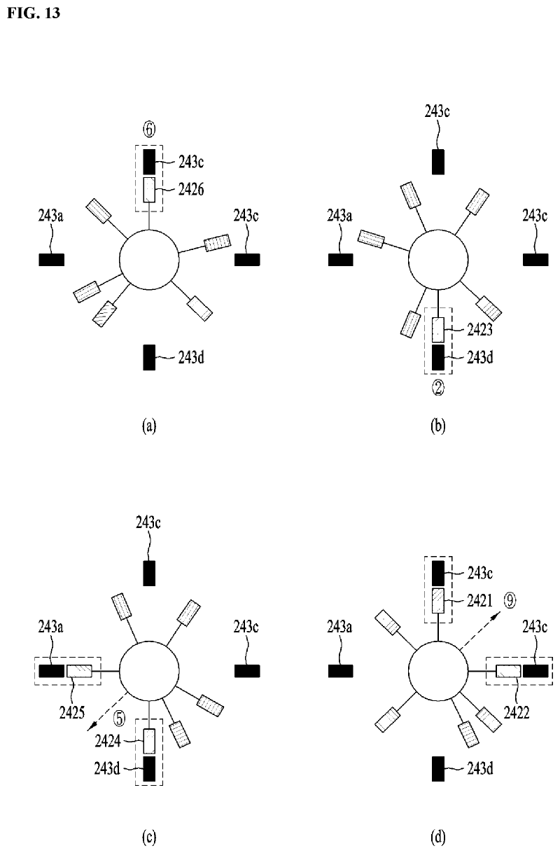

FIG. 12 is a view illustrating another example of an angle-of-view adjustment unit according to the present disclosure, and FIG. 13 is a view illustrating a method for controlling an inclined direction of a camera unit 220 by an angle-of-view adjustment unit 240 of FIG. 12.

In this embodiment, the moving magnet 242 of the aforementioned embodiment is repeatedly arranged two times, wherein the fourth moving magnet 242 is arranged at an interval of 15° from the third magnet 2423 clockwise, a fifth magnet is arranged at an interval of 90° clockwise and a sixth magnet is arranged at an interval of 45° clockwise. If an angle between the first magnet 2421 and the fourth magnet is 180°, the fourth magnet may be arranged to overlap the fixed magnet 243 when the first magnet 2421 is arranged to overlap the fixed magnet 243, whereby a problem occurs in that an angle of the camera unit 220 cannot be controlled. Therefore, the angle between the third magnet 2423 and the fourth magnet has an angle except 45° (for example, 15° or 30°).

If the rotary unit 241 is rotated as shown in FIG. 13(a), the sixth magnet is overlapped with the fixed magnet 243 and therefore the camera unit 220 is inclined toward a direction \textcircled{6}. If the rotary unit 241 is rotated at 30° counterclockwise and arranged as shown in FIG. 13(b), the camera unit 220 is inclined toward a direction \textcircled{2}. If the rotary unit 241 is rotated at 15° counterclockwise and arranged as shown in FIG. 13(c), the camera unit 220 is inclined toward a direction \textcircled{5}. If the rotary unit 241 is rotated at 30° counterclockwise and arranged as shown in FIG. 13(d), the camera unit 220 is inclined toward a direction \textcircled{9}.

In this embodiment, although the number of magnets is more than the aforementioned embodiment, the rotary unit is rotated at an angle smaller than that of the aforementioned embodiment, whereby the direction of the camera unit 220 may be controlled more quickly.

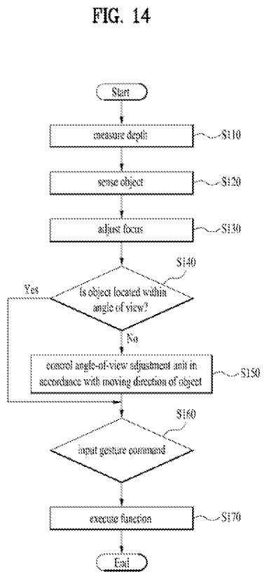

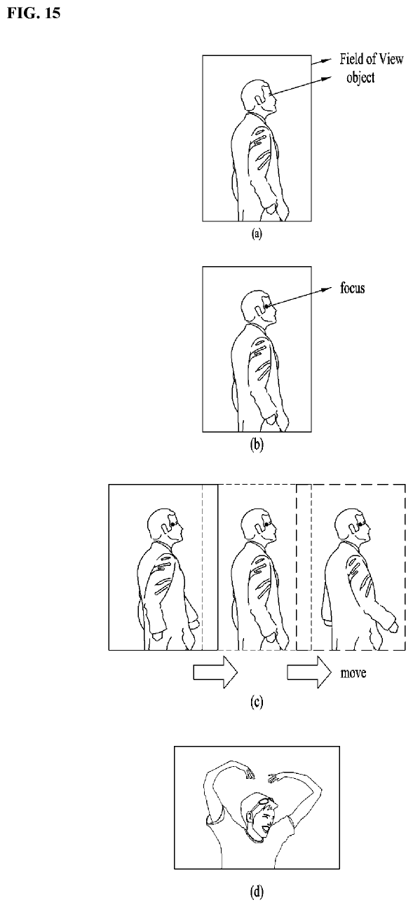

FIG. 14 is a view illustrating an algorithm for controlling a camera module 200 by a mobile terminal 100 according to the present disclosure, and FIG. 15 is a view illustrating a screen captured when a camera module 200 is controlled in accordance with FIG. 14.

In this embodiment, a depth camera is used as the camera unit 220, and may identify an area located at the same depth or an area having continuous depth as one object by measuring depth of an object located within an angle of view (S110 and S120, see FIG. 15(a)). The camera unit focuses on an object closest thereto or an object located at the center of a screen (S130, see FIG. 15(b) and continues to sense movement of the focused object. If the object moves and then departs from the angle of view (S140), the camera module 200 is inclined along a moving direction of the object to track the object (S150, see FIG. 15(c)).

In this way, if the camera module 200 senses a gesture corresponding to a user command for the object while tracking the object, the camera module 200 performs a function corresponding to the sensed gesture (S160 and S170). The gesture may be a hand operation or arm operation, and the camera module 200 may execute a function such as image pickup or video switching in accordance with the corresponding gesture.

Resolution that may check a finger's motion is required to sense a hand operation. Particularly, an image of higher resolution is required to sense a user's finger operation when a user is located to be far away from the camera. However, since a general depth camera has resolution more deteriorated than the general camera, it is difficult to obtain information of high resolution. If the camera module 200 of the present disclosure is used, a wide image of high resolution may be obtained by obtaining a wide angle of view image through the angle-of-view adjustment unit 240 in a state that resolution is enhanced within a narrow angle of view without widening the angle of view of the camera unit 220.

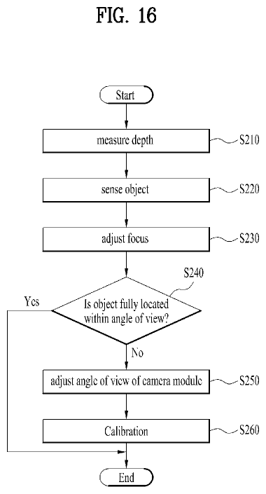

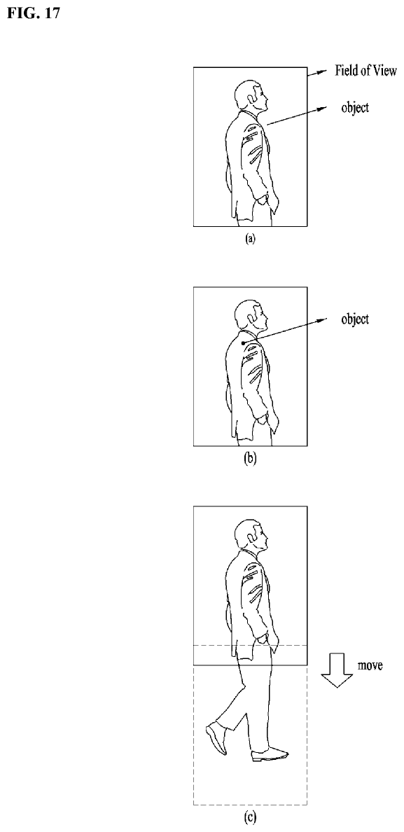

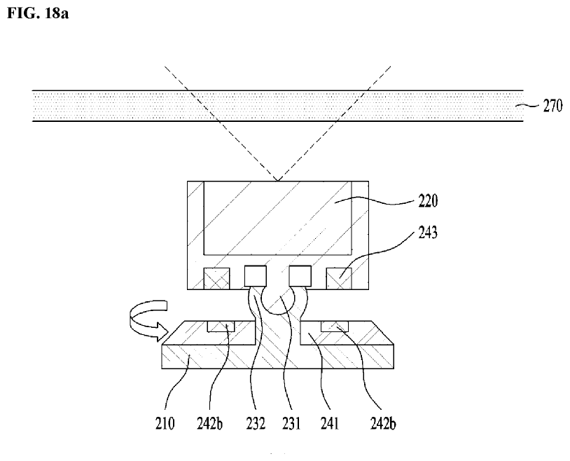

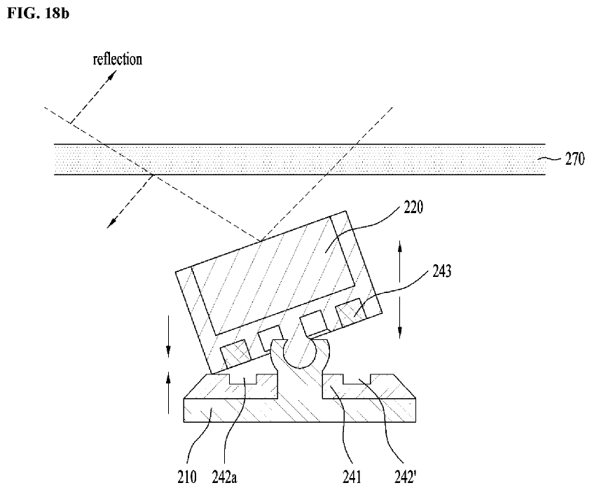

FIG. 16 is a view illustrating another algorithm for controlling a camera module 200 by a mobile terminal 100 according to the present disclosure, FIG. 17 is a view illustrating a screen captured when a camera module 200 is controlled in accordance with FIG. 16, and FIGS. 18a and 18b are views illustrating a light path in accordance with an angle of a camera module 200 of the present disclosure.

The camera unit 220 may identify an area located at the same depth or an area having continuous depth as one object by measuring depth of an object located within an angle of view (S210 and S220, see FIG. 17(a)). The camera unit 220 focuses on an object closest thereto or an object located at the center of a screen (S230, see FIG. 17(b) and adjusts an angle of view of the camera module 200 if the focused object (hereinafter, referred to as ‘focus object’) is not fully located within the angle of view (S240). If the focused object is not fully located within the angle of view, the camera unit 220 may be inclined toward a corresponding direction to obtain a depth image on the object when the area having the same depth reaches a boundary of the angle of view (S250, FIG. 17).

As shown in FIG. 18a, if the camera unit 220 is arranged toward a front surface, there is almost no reflection of light. However, as shown in FIG. 18b, if the angle of the camera unit 220 is changed, light is reflected from a camera glass that covers the front surface of the camera module 200 and the amount of light sensed by the camera unit 220 arranged in a forward direction is reduced, whereby a problem occurs in that it is difficult to perform exact measurement. To solve this problem, in the present disclosure, considering a reflectivity in a window based on the inclined angle of the camera unit 220, a controller 180 for calibrating depth sensed by the camera unit 220 may be provided (S260).

For this calibration, the memory stores data for reflectivity based on an incident angle of light from the window, and the controller 180 calibrate light reflected from the window in accordance with the inclination of the camera unit 220 by using the stored data.

The mobile terminal according to the present disclosure may widen the angle of view of the depth camera and obtain the depth image of high resolution.

The computer may include the controller 180 of the mobile terminal. The above detailed description should not be construed as being limitative in all terms, but should be considered as being illustrative. The scope of the present disclosure should be determined by reasonable analysis of the accompanying claims, and all changes in the equivalent range of the present disclosure are included in the scope of the present disclosure.

1. A mobile terminal comprising:
a main body;
a fixed unit located in the main body;
a camera unit that includes a lens;
a ball hinge connecting the camera unit with the fixed unit; and
an angle-of-view adjustment unit adjusting the ball hinge to control a direction of the lens of the camera unit.

2. The mobile terminal of claim 1, wherein the angle-of-view adjustment unit includes:
at least one fixed magnet located on a rear surface of the camera unit;
a rotary unit that includes a plurality of moving magnets located at the same distance from the ball hinge; and
a driver rotating the rotary unit based on the ball hinge, and
the camera unit is inclined based on the ball hinge in accordance with magnetism of the moving magnet facing the fixed magnet.

3. The mobile terminal of claim 2, wherein the moving magnet includes a plurality of moving magnets having different magnetic forces.

4. The mobile terminal of claim 2, wherein the moving magnets are grouped as much as N, and N moving magnets of the same group are arranged at constant intervals.

5. The mobile terminal of claim 2, wherein the fixed magnet includes a plurality of fixed magnets which all belong to a first pole.

6. The mobile terminal of claim 5, wherein the fixed magnet includes four magnets arranged at an interval of 90°, and the moving magnet includes a first moving magnet, a second moving magnet arranged to be spaced apart from the first moving magnet at 90°, and a third moving magnet arranged to be spaced apart from the second moving magnet at 45°.

7. The mobile terminal of claim 1, further comprising a bracket located around the camera unit, wherein the bracket includes an inclined surface facing the camera unit, widened toward an outer side.

8. The mobile terminal of claim 7, further comprising an elastic pad attached to the inclined surface.

9. The mobile terminal of claim 1, wherein the ball hinge includes:
a ball coupled to the camera unit; and
a ball housing surrounding the ball, and
the ball housing is provided with an entrance which is smaller than a maximum diameter inside the ball housing and made of a flexible material.

10. The mobile terminal of claim 1, wherein the camera unit includes a depth camera sensing a distance.

11. The mobile terminal of claim 1, further comprising:
a case forming an external appearance of the main body and including a camera hole at a position corresponding to the camera unit;
a camera window located in the camera hole; and
a controller controlling brightness of the camera by calibrating light reflected from the camera window in accordance with a direction of the camera unit.

12. The mobile terminal of claim 1, further comprising a controller selecting a subject based on distance information acquired through the lens of the camera unit and controlling the angle-of-view adjustment unit to allow the camera unit to be inclined toward a moving direction of the subject if the subject moves.

13. The mobile terminal of claim 1, further comprising a controller selecting a focal distance based on distance information acquired through the lens of the camera unit and controlling the angle-of-view adjustment unit toward an angle-of-view boundary where an object located within the focal distance is located when the object is located in the angle of view boundary of the camera unit.
